(19) United States
(12) Patent Application Publication
(10) Pub. No.: US 2013/0026830 A1
(43) Pub. Date: Jan. 31, 2013

(54) Device adaptive Power Management System

(71) Applicant: A. Vernon Wright, Newport Beach, CA (US)

(72) Inventor: A. Vernon Wright, Newport Beach, CA (US)

(21) Appl. No.: 13/239,289

(22) Filed: Sep. 21, 2011

Related U.S. Application Data
(60) Provisional application No. 61/512,877, filed on Jul. 28, 2011.

(51) Int. Cl. H02J 1/00

(52) U.S. Cl. 307/11

(57) ABSTRACT

A power management apparatus is operable to regulate power to an attached powered device according to power requirements of the device. The illustrative power management apparatus can comprise a power input connector, at least one power output connector, and at least one power control circuit. The at least one power output connector is operable to supply power to powered devices characterized by a plurality of power characteristics. The at least one power control circuit is operable to determine a power characteristic of a powered device connected to the at least one power output connector and to supply power to the powered device in compliance with the power characteristic.

### BACKGROUND

A battery charger is a device used to transfer energy into a secondary cell or rechargeable battery by passing through electric current.

The charge current depends upon the technology and capacity of the battery being charged. For example, a suitable current for recharging a twelve-volt car battery is very different from the current for a mobile phone battery.

### SUMMARY

Embodiments of a power management apparatus are operable to regulate power to an attached powered device according to power requirements of the device. The illustrative power management apparatus can comprise a power input connector, at least one power output connector, and at least one power control circuit. The at least one power output connector is operable to supply power to powered devices characterized by a plurality of power characteristics. The at least one power control circuit is operable to determine a power characteristic of a powered device connected to the at least one power output connector and to supply power to the powered device in compliance with the power characteristic.

### BRIEF DESCRIPTION OF THE DRAWINGS

Embodiments of the invention relating to both structure and method of operation may best be understood by referring to the following description and accompanying drawings:

FIGS. 1A, 1B, 1C, and 1D are schematic block diagrams illustrating an embodiment of a power management apparatus operable to regulate power to an attached powered device according to power requirements of the device.

### DETAILED DESCRIPTION

Embodiments of a power management apparatus are operable to regulate power to an attached powered device according to power requirements of the device.

Some embodiments of the power management apparatus can safely recharge devices with a wide range of electrical and power characteristics.

Some embodiments of the power management apparatus can be powered remotely from grid electrical power, for example via solar or battery energy, to enable field usage.

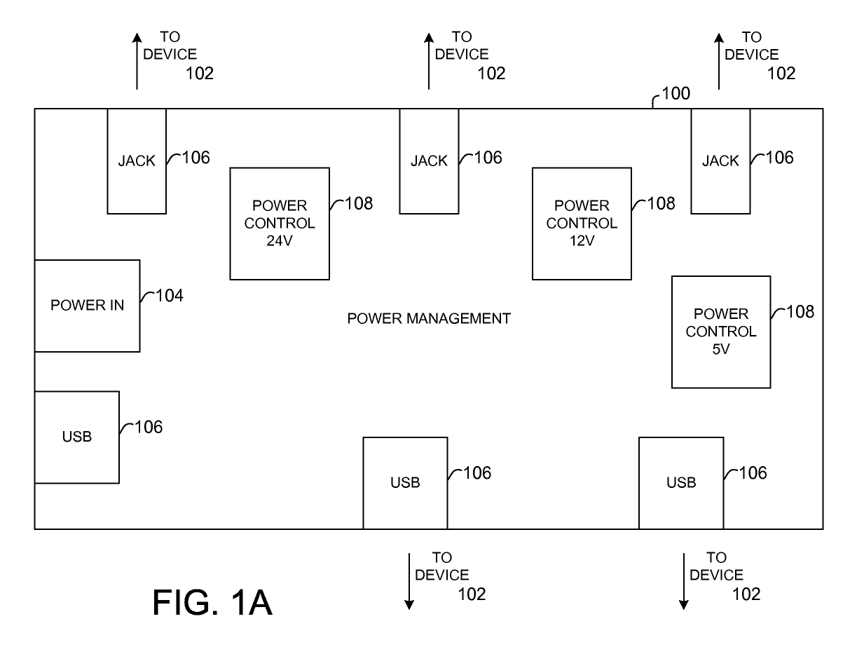

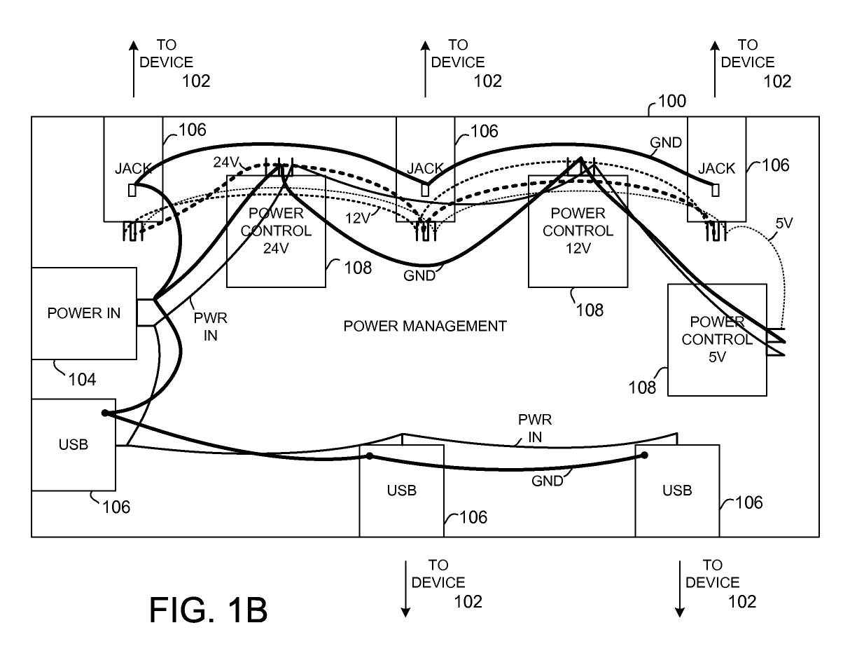

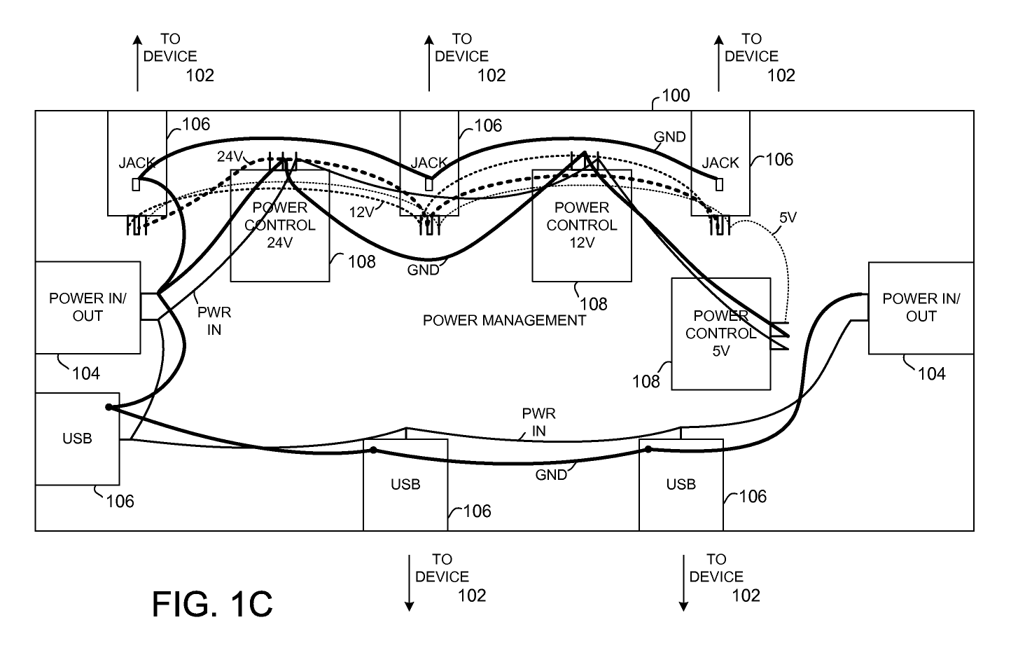

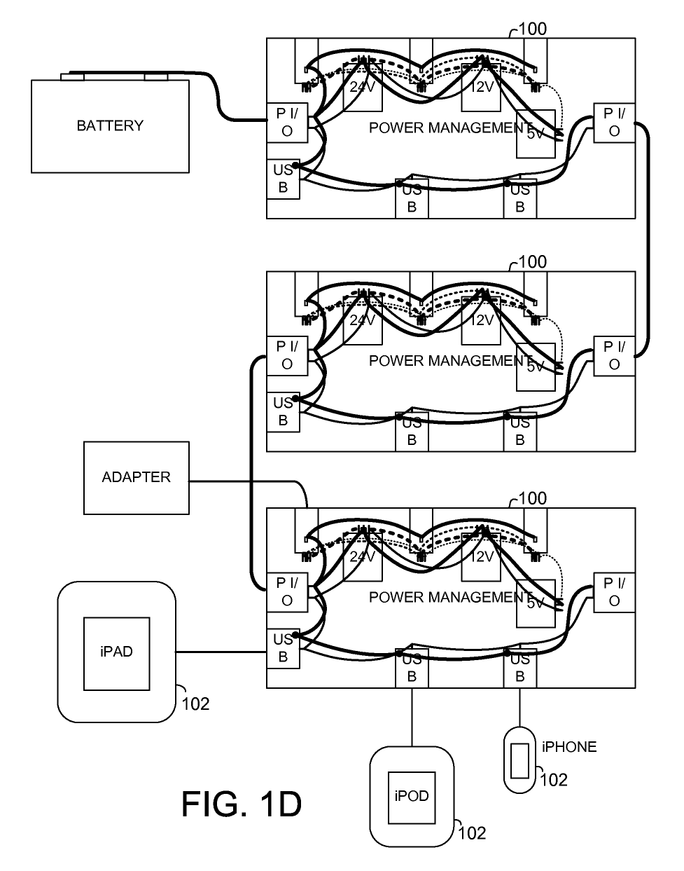

Referring to FIGS. 1A, 1B, 1C, and 1D, schematic block diagrams illustrate embodiments of a power management apparatus 100 operable to regulate power to an attached powered device 102 according to power requirements of the device 102. The illustrative power management apparatus 100 can comprise a power input connector 104, at least one power output connector 106, and at least one power control circuit 108. The at least one power output connector 106 is operable to supply power to powered devices 102 characterized by a plurality of power characteristics. The at least one power control circuit 108 is operable to determine a power characteristic of a powered device 102 connected to the at least one power output connector 106 and to supply power to the powered device 102 in compliance with the power characteristic.

In some embodiments, the at least one power output connector 106 can comprise at least one Universal Serial Bus (USB) connector.

In some embodiments, the at least one power output connector 106 can comprise at least one connector jack.

In some embodiments, the at least one power output connector 106 can comprise at least one audio output jack.

In some embodiments, the at least one power output connector 104 can comprise at least one Universal Serial Bus (USB) connector and at least one connector jack.

In some embodiments, the at least one power output connector 106 can comprise at least one output connector operable to connect a plurality of powered devices in series as shown in FIGS. 1C and 1D.

In other embodiments, the power output connectors 106 can be any suitable connector.

In some embodiments, the power input connector 104 can be operable for connecting to a solar power source.

In some embodiments, the power input connector 104 can be operable for connecting to a battery.

In some embodiments, the power input connector 104 can be operable for connecting to any suitable power source including, for example, line power, a generator, and the like.

In some embodiments, the at least one power control circuit 108 can be operable to determine a power requirement of a powered device connected to the at least one power output connector and to regulate power to the determined power requirement.

For example, the power control circuit 108 can read the pins of a USB device connected to a power output connector 106 to determine power characteristics of the USB device.

In some embodiments, the at least one power control circuit 108 can comprise blocking diodes operable to restrict power for charging the powered device.

In some embodiments, the at least one power control circuit 108 can be operable to determine a voltage requirement of a powered device connected to the at least one power output connector and to regulate voltage to the determined requirement.

In some embodiments, the at least one power control circuit 108 can be operable to determine a current requirement of a powered device connected to the at least one power output connector and to regulate current to the determined requirement.

In an example embodiment, the power management apparatus 100 can be a Power Management System (PMS) configured in a small chassis, for example a housing or box of dimensions 3″×2″×1″ and weighing about 5 oz, although any suitable size and weight may be selected. The PMS can be used to replace an 8 to 9 pound laptop size device which permits powered devices, such as Military Field Units in a military application, to be plugged into a recharging station. The reduced size and weight of the PMS can enable a user, such as military personnel, to carry two (2) or more to charge between 6 to 12 radios, night vision optical devices, Global Positioning System (GPS), Satellite telephones, computers, cell phones, laser designators, and the like.

In an example embodiment, the power management apparatus 100 and all powered devices can be charged using a solar power source such as a “Solar Vest” panel which can supply, for example, provides 25 volts of power. Similarly, some embodiments of the power management apparatus 100 and all powered devices can be charged using a battery “Brick” which generates 20 volts of power.

In some embodiments, the power control circuit 108 can be micro-circuit chips which can attach to USB or stereo speaker jacks. The micro-circuit chips determine the power required by a device needing charged and regulate the output charge to the recognized power requirement. In example configuration of the power management apparatus 100 can simultaneously supply multiple voltages. For example, in a military application, the military typically imposes three (3) recharge requirements: 5 v, 12 v and 24 v, as shown in FIG. 1B. The micro-chip can detect the power requirement and then with blocking diodes restrict the amount of power used to charge the device. The PMS can have a power-out to permit a number of devices to be operated in series.

In a military application, military personnel using the PMS is preventing from using an incorrect power amount because the micro-circuits can detect the proper amperage, then block any higher power. The PMS can be used in military or commercial applications to regulate and control the amount of amperage needed by multiple devices simultaneously. The PMS can use micro-circuitry to automatically detect the proper amperage.

Although any suitable battery can be used to power the PMS, in some applications a Lithium Polymer battery can be used.

Terms “substantially”, “essentially”, or “approximately”, that may be used herein, relate to an industry-accepted variability to the corresponding term. Such an industry-accepted variability ranges from less than one percent to twenty percent and corresponds to, but is not limited to, materials, shapes, sizes, functionality, values, process variations, and the like. The term “coupled”, as may be used herein, includes direct coupling and indirect coupling via another component or element where, for indirect coupling, the intervening component or element does not modify the operation. Inferred coupling, for example where one element is coupled to another element by inference, includes direct and indirect coupling between two elements in the same manner as “coupled”.

The illustrative pictorial diagrams depict structures and process actions in a manufacturing process. Although the particular examples illustrate specific structures and process acts, many alternative implementations are possible and commonly made by simple design choice. Manufacturing actions may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, shapes, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A power management apparatus comprising:
a power input connector;
at least one power output connector operable to supply power to powered devices characterized by a plurality of power characteristics; and
at least one power control circuit operable to determine a power characteristic of a powered device connected to the at least one power output connector and to supply power to the powered device in compliance with the power characteristic.

2. The power management apparatus according to claim 1 wherein:
the at least one power output connector comprises at least one Universal Serial Bus (USB) connector.

3. The power management apparatus according to claim 1 wherein:
the at least one power output connector comprises at least one connector jack.

4. The power management apparatus according to claim 1 wherein:
the at least one power output connector comprises at least one audio output jack.

5. The power management apparatus according to claim 1 wherein:
the at least one power output connector comprises at least one Universal Serial Bus (USB) connector and at least one connector jack.

6. The power management apparatus according to claim 1 wherein:
the at least one power output connector comprises at least one output connector operable to connect a plurality of powered devices in series.

7. The power management apparatus according to claim 1 wherein:
the power input connector is operable for connecting to a solar power source.

8. The power management apparatus according to claim 1 wherein:
the power input connector is operable for connecting to a battery.

9. The power management apparatus according to claim 1 wherein:
the at least one power control circuit is operable to determine a power requirement of a powered device connected to the at least one power output connector and to regulate power to the determined power requirement.

10. The power management apparatus according to claim 9 wherein:
the at least one power control circuit comprises blocking diodes operable to restrict power for charging the powered device.

11. The power management apparatus according to claim 1 wherein:
the at least one power control circuit is operable to determine a voltage requirement of a powered device connected to the at least one power output connector and to regulate voltage to the determined requirement.

12. The power management apparatus according to claim 1 wherein:
the at least one power control circuit is operable to determine a current requirement of a powered device connected to the at least one power output connector and to regulate current to the determined requirement.
